(19) United States
(12) Patent Application Publication
(10) Pub. No.: US 2010/0119911 A1
(43) Pub. Date: May 13, 2010

(54) LIQUID ELECTROLYTE FUEL CELL HAVING HIGH PERMEABILITY WICKING TO RETURN CONDENSED ELECTROLYTE

(76) Inventors: Carl A. Reiser, Stonington, CT (US); Richard D. Breault, North Kingston, RI (US)

Correspondence Address: M P Williams, 210 Main Street, Manchester, CT, 06042, US

(21) Appl. No.: 12/448,144

(22) PCT Filed: Dec. 22, 2006
(86) PCT No.: PCT/US06/49246

§ 371 Date: Jun. 10, 2009

(51) Int. Cl. H01M 2/00

(52) U.S. Cl. 429/34

(57) ABSTRACT

A liquid electrolyte fuel cell power plant (6) includes a stack (7) of fuel cells (8) demarcated by fluid impermeable separator plates (19, 23) with additional wicking to ensure backflow of condensated electrolyte from a condensation zone (27) back through the active area of the fuel cells. Wicking material (49) is disposed in channels interspersed with reactant gas channels (20, 21); wicking material (54) is disposed in zones (53) formed within electrode substrates (16, 17); wicking material (58) is disposed on the base surface of reactant gas channels (20, 21); wicking material (62) is disposed between the ribs (50) of the separator plates (19, 23) and the adjacent surfaces of the substrates (16, 17); and wicking material (65) is formed as ribs on planar separator plates (19a, 23a), the spaces between the wicking ribs (65) comprising the reactant gas channels (20, 21).

### TECHNICAL FIELD

Liquid electrolyte fuel cells include fine pore, high permeability wicking between each electrode substrate and the separator plate on the anode side and/or the cathode side to enhance transfer of condensed electrolyte from a condensation zone back through the remainder of the cell on the respective side.

### BACKGROUND ART

There are two approaches to providing acid to a phosphoric acid fuel cell to replenish acid loss with time, due to evaporation into the reactant streams. There are known acid addition approaches where acid in a liquid or vapor form is continuously or periodically added to the cells. These approaches are complicated and expensive. The more preferred approach is a passive approach where sufficient acid to satisfy the life requirements of the cell is incorporated into porous components in the cell during the initial assembly of the cell.

Conventional phosphoric acid fuel cell power plants typically comprise stacks 7 of fuel cells 8, as shown in FIG. 1, the temperature of the fuel cells being controlled by a coolant that passes through cooler plates 9 interposed between groups of between five and ten fuel cells. Referring to FIG. 2, each fuel cell 8 comprises an acid retaining matrix 11 having anode catalyst 12 on one side and cathode catalyst 13 on the other side. The catalysts are respectively supported by a porous anode substrate 16 and a porous cathode substrate 17. Porous anode substrate 16 and porous cathode substrate 17 are hydrophilic as is known in the art. The fuel cells (except at the ends of the stack or adjacent to cooler plates) share non-porous, hydrophobic separator plate assemblies 19 which include fuel channels 20 adjacent the anode substrate 16 and air (or other oxidant) channels 21 adjacent the cathode substrate 17. The reactant gases in the channels 20, 21 diffuse through respective substrates 16, 17; hence the reference to gas diffusion layers (GDLs). Adjacent a cooler plate 9, the fuel flow channels 20 may be formed in a fuel flow field plate 23 which does not have air flow channels therein; similarly for the cathode side.

The terms “non-porous” and “hydrophobic”, as used herein with respect to the separator plates 19, mean that the separator plates 19 are sufficiently non-porous and hydrophobic so that substantially no liquid electrolyte penetrates the separator plates.

As shown in FIG. 2, the traditional phosphoric acid fuel cell has a substrate 16 adjacent the anode catalyst 12 which is of substantially the same thickness as the substrate 17 adjacent the cathode catalyst 13. However, the anode substrate may be thicker than the cathode substrate, as disclosed by Breault in PCT/US06/42495, filed Oct. 27, 2006.

In normal operation of a liquid electrolyte fuel cell stack, electrolyte is evaporated into both of the reactant gas streams, as the reactant flows from the inlet to the exit. In order to retain acid for an extended life of the fuel cell power plant, the condensation of vaporized liquid electrolyte is accomplished near the exit of the reactant gas, so as to recover substantially all of the electrolyte.

In U.S. Pat. No. 4,345,008, retention of the liquid electrolyte is improved significantly by provision of a condensation zone to recover electrolyte vapor that has evaporated into one or both of the reactant gas flows.

Referring to FIG. 3, an exemplary fuel cell power plant 6 has a stack 7 which includes fuel cells 8, each having a condensation zone 27. In FIG. 3, the dotted line demarcates the extent of the catalyst 12, 13 and the dash lines demarcate the three groups of fuel flow channels through which the fuel flows in succession. Therein, the matrix 11 extends throughout the overall planform 28, but the catalysts 12, 13 extend over only a portion of the overall planform forming an active area 29, leaving an inactive area in the remainder of the overall planform, which constitutes an acid condensation zone 27.

Alternatively, the anode catalyst may extend over the whole planform while the cathode catalyst 13 extends over only a portion of the planform, as disclosed by Breault et al in WO2006071209A1.

In the example of FIGS. 1-3, the fuel cell power plant includes a source of fuel 30 applied through a fuel inlet manifold 31 to fuel flow fields (20, FIG. 2), the fuel flowing through a portion of each fuel cell to the right as shown in FIG. 3 to a turn manifold 32 and then flowing to the left as shown in FIG. 3. Then the fuel flows through a second turn manifold 32 and to the right through the remaining portion of each of the fuel cells to a fuel exit manifold 33, where the fuel flows out, to either a fuel recycle arrangement, fuel processing, or ambient.

The fuel cell power plant 25 also includes a pump 37 for causing an oxidant-containing gas such as air to flow from an air inlet manifold 38 through all of the fuel cells to an air exit manifold 39. The air may then be provided to further processing, such as an enthalpy exchange device, fuel processing apparatus, or ambient. The condensation zone 27 coincides with the last pass of fuel through the cells, and is at the exit end of the air flow channels 21 (FIG. 2). Typically, cooling may be concentrated near the condensation zone so as to provide a low enough temperature for adequate condensation to recover substantially all of the electrolyte, as is known in the art.

Phosphoric acid fuel cell stacks have a significant temperature distribution along the air flow path. This results in phosphoric acid evaporating into the gas streams towards the inlet of the cell and condensing out of the gas streams towards the cell exit. Acid is continuously wicked, by the influence of capillary flow, through the porous cell components, from the cooler condenser zone back to the hotter evaporator zone. This internal reflux must be sustained to prevent dryout of the matrix and seals, which would lead to cell failure.

There are competing requirements for the electrode support substrates in liquid electrolyte fuel cells. Generally speaking, large pores and high porosity are desired to maximize the amount of electrolyte that can be stored therein. Large pores and high porosity are also favorable to the diffusion of reactant gases from the reactant flow channels to the catalysts. The pore size, porosity and design fill level are chosen to provide maximal electrolyte storage with more than adequate diffusion of reactant gases.

There is a concern that the rate of backflow of acid will be inadequate at low electrolyte fill levels representative of cells that are 5 to 10 years old. Advanced designs, where both the anode and cathode porous electrolyte reservoir plates are replaced by dense graphite-Teflon® flow fields, will tax in-plane acid transfer even further.

Proton-conducting liquid electrolytes which may be used as alternatives to phosphoric acid are known. U.S. Pat. No. 5,344,722 discloses an electrolyte which is a mixture of phosphoric acid and a fluorinated compound or a mixture of phosphoric acid and siloxanes. U.S. Publication No. 2006/0027789 discloses a proton-conducting liquid electrolyte where the anion is a fluoroborate or fluoroheteroborate

### SUMMARY

The subject improvement takes into account the fact that while large pores reduce resistance to flow of liquid, small pores increase the capillarity, and therefore the capillary pressure that can move the liquid through the pores.

While the use of wicks to transport fluids, in fuel cells that contain solid flow field plates and wetproofed substrates (gas diffusion layers), from a liquid condensing zone to a liquid evaporation zone is known, the use of wicks in cells with hydrophilic (wettable) substrates is not known and has unique requirements.

In cells with wettable substrates, there are several parallel paths that can wick acid from an acid condensation zone to an acid evaporation zone. Those paths are the anode substrate, the cathode substrate, and the electrolyte retaining matrix. The amount of acid that is wicked through a particular path is dependent on its cross-sectional area and permeability. The characteristics of any additional wick which is incorporated into the cell must be established relative to the characteristics of the existing materials for it to be effective.

Porous Media: Fluid Transport and Pore Structure, Second Edition, Dullien, Academic Press, San Diego, 1992 shows that the permeability is a complicated function of pore size, porosity and the degree of saturation of the porous media with liquid. The equation presented by Dullien for permeability is:

$$k = \frac{{CD}_{p}^{2} {E}^{3} {S}^{3.3}}{{( 1 - E )}^{2}}$$

where k=permeability, Dₚ=pore size, E=porosity, C=constant and S=% saturation with liquid.

It has now been found that an effective wick must have a high degree of liquid saturation relative to the electrode substrate, and further, that this dictates that the mean pore size of the wick should be less than about 50% of the mean pore size of the substrate, and preferably less than about 25% of the mean pore size of the substrate.

Substrates used in typical fuel cells have mean pore size on the order of 20 to 50 microns with approximately 30 microns being preferred. To improve backflow of liquid electrolyte in a fuel cell, in addition to the wicking provided by the substrates, wicking is accomplished by means of additional porous hydrophilic material having mean pore size less than about one-half the mean pore size of the substrates, disposed between each separator plate and one or both of the substrates.

In one form, the additional wicking material is disposed in grooves which are interspersed with every third or fourth (or other number) of reactant gas grooves in the separator plate. In another form, the additional wicking material is disposed in zones extending from a surface of a separator plate into a substrate; the zones may preferably extend only part way through each substrate plate, but may extend completely through the substrate plate; the zones may preferentially be formed so as to match face-to-face with the ribs (between grooves) in the adjacent reactant gas flow field of the separator plate. In another form, the additional wicking material may be disposed on a base surface of reactant gas grooves, leaving adequate cross-sectional area for sufficient reactant gas flow. In another form, the additional wicking material is disposed between the surface of at least one of the substrates and the facing surface of the ribs between reactant gas flow field channels in the separator plates. In still another form, wicking material is disposed on dense, planar, hydrophobic separator plates to form ribs, the spaces between the formed wicking material ribs comprising the reactant gas flow field channels for either or both of the anode and the cathode reactant gases.

The wicking material can be disposed by well-known processes, such as screen printing. The wick material must be wettable and chemically compatible with the fuel cell electrolyte and operating conditions, and may consist of well-known materials such as silicon carbide or carbon or graphite in various forms such as particulates, flakes and fibers. The pore size, particle size, porosity and percent coverage in the various forms should be established so that the wick is nearly saturated when the electrolyte reservoirs (the substrates) are nearly empty, thereby to ensure good in-plane transfer. While the electrolyte transfer path starts in the condensation zone, the specific end point will be determined by the particular stack design and its associated evaporation zone.

Other improvements, features and advantages will become more apparent in the light of the following detailed description of exemplary embodiments, as illustrated in the accompanying drawings.

### BRIEF DESCRIPTION OF THE DRAWINGS

FIG. 1 is a simplified, schematic, side elevation view of a phosphoric acid fuel cell stack known to the prior art.

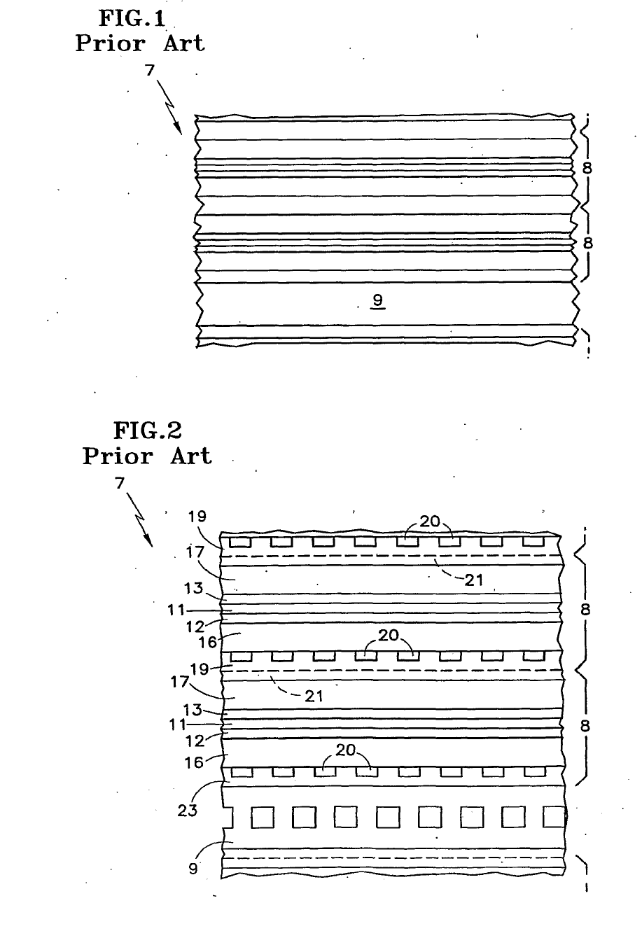

FIG. 2 is a fragmentary, simplified, sectioned side elevation view of a pair of fuel cells and a cooler plate in a phosphoric acid fuel cell stack known to the prior art, not to scale, with sectioning lines omitted for clarity.

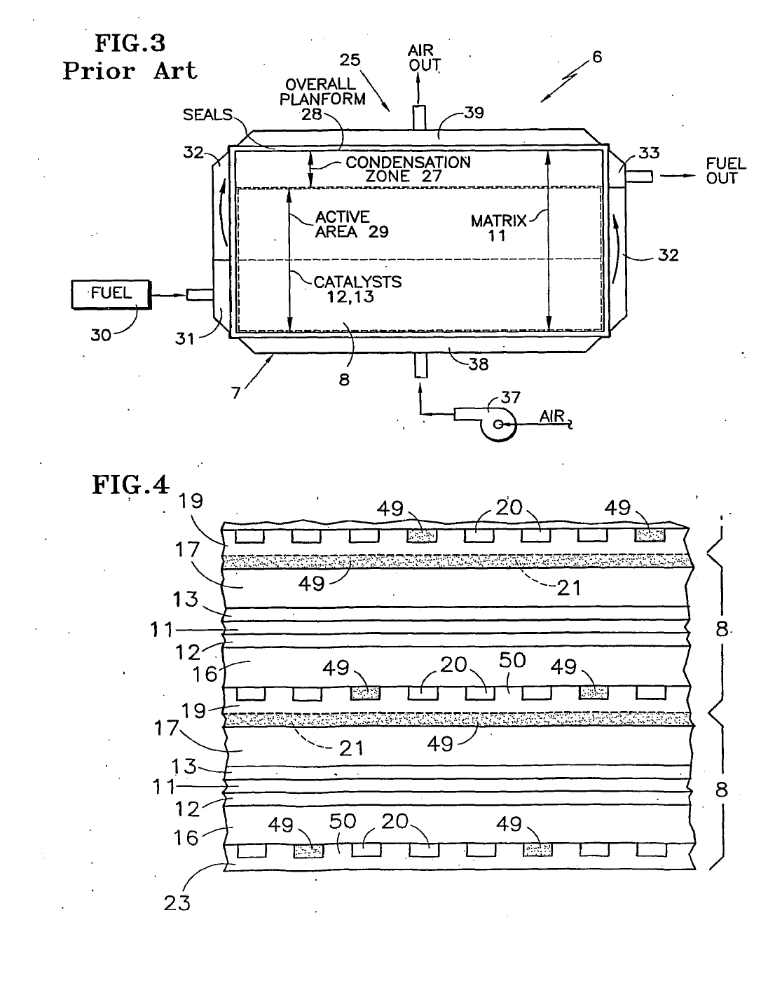

FIG. 3 is a simplified, stylized top plan view of a fuel cell power plant known to the prior art.

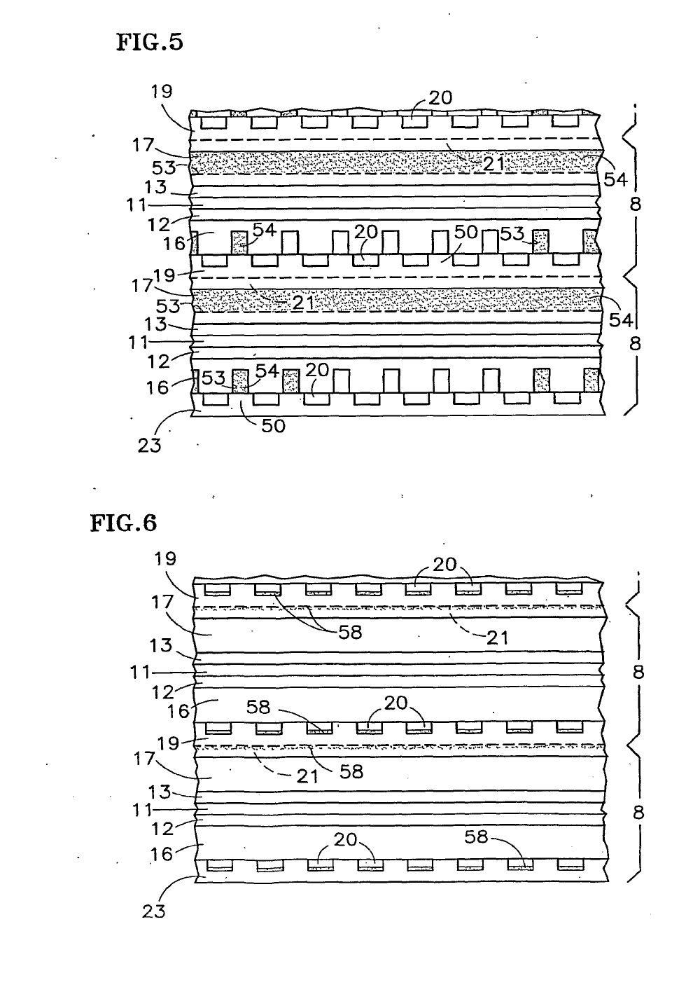

FIGS. 4-8 are fragmentary, simplified, sectioned side elevation views of a pair of phosphoric acid fuel cells having various forms of the improvement herein, not to scale, with sectioning lines omitted for clarity, and with stippling to emphasize the position of wicking material of the present improvement.

### MODE(S) OF IMPLEMENTATION

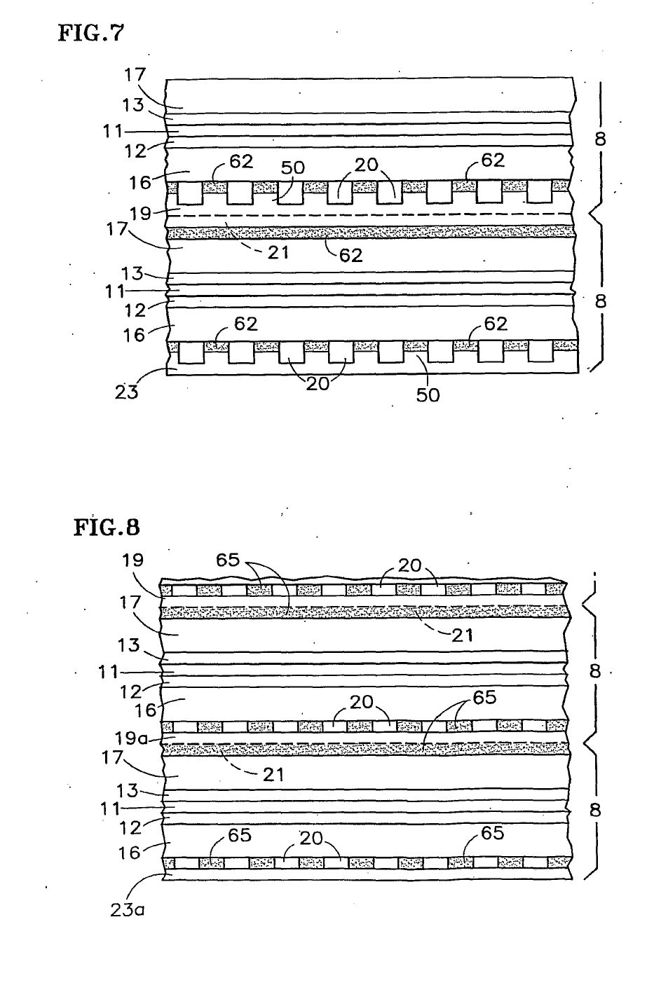

A first form of the invention shown in FIG. 4 provides wicking material 49 in every fourth fuel channel 20 or air channel 21. Although illustrated in FIG. 4 as if the wicking material 49 were simply inserted in the air or fuel channels, channels of different configuration than the air and fuel channels may be utilized in any given implementation of the improvement. Furthermore, the periodicity may be other than 1 in 4, such as one channel having wicking material for every N reactant gas channels, where N is a positive integer greater than one.

In a typical phosphoric acid fuel cell stack, the mean pore size of the substrates 16, 17 may be on the order of between 20 and 50 microns; wicking material utilized for the present improvement has, in contrast, mean pore size less than about one-half of the mean pore size of the substrates and preferably about 25% of the mean pore size of the substrate.

A second form of the invention illustrated in FIG. 5 includes zones 53 formed in the substrates 16, 17, with wicking material 54 disposed therein. The zones 53 may be formed by screen printing an ink containing a silicon carbide or carbon particle into the electrode substrate by known techniques. In the example of FIG. 5, the zones 53 do not extend completely through the substrates 16, 17, but zones with wicking which do extend fully through the substrates 16 and 17 may be utilized in any implementation of the improvement herein. The zones 53 are shown in the example of FIG. 5 as being disposed in a face-to-face relationship with the ribs 50 of the separator plates 19, 23; this provides a minimal interference with the flow of reactant gas from the reactant gas flow channels 20, 21 to the electrodes 12, 13. However, the improvement herein may be implemented with the zones 53 disposed in a random fashion, or any other fashion with respect to the ribs 50.

In the improvement illustrated in FIG. 6, the wicking material 58 is disposed at the base surface of the reactant gas channels 20, 21. Since the material provides no structural or electrical function, the material may be deposited utilizing known screen printing techniques. In this form, the reduced cross section of reactant gas flow channels will typically result in a higher pressure drop across the reactant flow fields. This in turn will result in a slightly higher parasitic load on the fuel cell power plant to provide the additional pressure in the oxidant channels, but is typically easily provided in the fuel cell channels by a simple adjustment of a fuel pressure control valve. Alternatively, the channels may be made deeper or wider to maintain adequate flow cross section.

In the forms of the improvements of FIGS. 4-6, the wicking material porosity may be in excess of 50% or 60% and the pore size and porosity may be selected simply for the desired acid flow characteristics, since the wicking performs no structural or electrical function whatsoever.

In the form illustrated in FIG. 7, the wicking material 62 is disposed between the substrates 16, 17 and the facing surface of the corresponding ribs 50 of the separator plates 19, 23. In this instance, the wicking material 62 must provide high electrical conductivity and have sufficient strength so as to withstand compression in the stack between the end plates. Therefore, the porosity may have to be below 50% and the thickness limited to on the order of 125 microns (0.005 inches). Since adding material to the rib faces of the separator plates 19, 23 will result in larger air channels, the width of the air channels may be reduced so that the ribs are wider, thereby making it easier to facilitate the design of wick material 62 that will withstand the mechanical stresses, while preserving sufficient porosity to provide the improved electrolyte backflow described herein.

An extension of the form described with respect to FIG. 7 is illustrated in FIG. 8. Therein, the wicking material 65 is formed on dense, hydrophobic separator plates 19a, 23a which are planar, that is, both surfaces being flat. In this case, the wicking material 65 must supply the electrical and mechanical requirements of ribs and may comprise carbon or graphite particles screen printed onto the planar, dense, hydrophobic separator plates 19a, 23a. The planar separator plates may be electrically conductive carbon-plastic composite, or otherwise.

Throughout the foregoing disclosure, the provision of wicking material is disclosed on both the anode side and the cathode side of the fuel cells. Even though the larger quantity of electrolyte evaporation occurs within the air flow, and therefore the greatest proportion of condensed electrolyte appears in the air flow channels within the condensation zone, nonetheless there is significant evaporation and condensation of electrolyte within the fuel flow channels. However, in some instances, it may be possible to utilize a lesser amount of wicking material (e.g. 62, 65) with respect to the fuel flow channels 20 than is required with respect to the air flow channels 21 or vice versa. This may assist in limiting the bulk size of the fuel cell stack and improve the electrical and mechanical properties thereof.

1. Fuel cell apparatus, comprising:
a stack (7) of contiguous fuel cells (8), each cell having a pair of electrodes including an anode catalyst (12) disposed on a wettable, porous anode substrate (16) and a cathode catalyst (13) disposed on a wettable, porous cathode substrate (17), and a matrix (11) configured to hold a liquid electrolyte disposed between said catalysts;
a plurality of fluid impermeable separator plates (19) interspersed between said fuel cells, said separator plates having channels at opposite surfaces thereof including fuel reactant gas flow channels (20) at one surface and oxidant reactant gas flow channels (21) at a second surface opposite to said one surface;
characterized by:
porous, hydrophilic wicking material (49, 53, 58, 62, 65) configured to conduct electrolyte substantially coextensively with channels selected from said fuel reactant gas flow channels and said oxidant reactant gas flow channels, said wicking material having a mean pore size less than about one-half of the mean pore size of the pores in said substrates.

2. Apparatus according to claim 1, further characterized by:
said wicking material (49, 53, 58, 62, 65) having a mean pore size less than about one-quarter of the mean pore size of the pores in said substrates.

3. Apparatus according to claim 1, further characterized by:
said wicking material disposed in each cell (a) within (49, 58) at least one of said substrates (16, 17), or (b) within (54) at least one of said separator plates (19), or (c) between (62, 65) at least one of said substrates (16, 17) and the corresponding adjoining separator plate (19).

4. Apparatus according to claim 1, further characterized by:
said separator plates (19) being planar with substantially flat opposed surfaces; and
said wicking material comprising a plurality of ribs (65) disposed contiguously between (a) one or both surfaces of each separator plate and (b) corresponding substrates (16, 17), said ribs on surfaces adjacent to the anode substrates forming said fuel reactant gas flow channels, and said ribs adjacent the cathode substrates forming said oxidant reactant gas flow channels, said ribs providing both electrical continuity with and mechanical separation between said substrates and said separator plates.

5. Apparatus according to claim 1, further characterized by:
said separator plates (19) having additional channels extending inwardly from at least one of said opposite surfaces interspersed with substantially every N reactant gas flow channel (20, 21) extending from said at least one of said opposite surfaces, where N is a positive integer greater than one, and said wicking material (49) is disposed within said additional channels.

6. Apparatus according to claim 1, further characterized by:
said wicking material (49, 58) is disposed in at least some of said reactant gas flow channels (20, 21) extending inwardly from at least one of said opposite surfaces.

7. Apparatus according to claim 1, further characterized by:
said wicking material (58) covering the base surface of substantially all of said reactant gas flow channels (20, 21) extending inwardly from at least one of said opposite surfaces.

8. Apparatus according to claim 1, further characterized by:
said separator plates (19) having ribs (50) defining said reactant gas flow channels (20, 21), and said wicking material (62) is disposed between one or both of said substrates (16, 17) in each cell and the surfaces of the ribs of said separator plates facing said one or both substrates.

9. Apparatus according to claim 1, further characterized by:
said wicking material (54) is disposed in each cell within zones (53) extending inwardly from a surface of at least one of said substrates (16, 17) in each cell adjacent to a corresponding one of said separator plates (19).

10. Apparatus according to claim 9, further characterized by:
said zones (53) extending only part way through said corresponding substrates (16, 17).

11. Apparatus according to claim 1, further characterized by:
a first amount of said wicking material (49, 53, 58, 62, 65) configured to conduct electrolyte substantially coextensive with said fuel reactant gas flow channels (20);
a second amount of said wicking material configured to conduct electrolyte substantially coextensive with said oxidant reactant gas flow channels (21); and
said first amount differing from said second amount.

12. Fuel cell apparatus, comprising:
a stack (7) of contiguous fuel cells (8), each cell comprising:
an electrolyte matrix (11) configured to hold a liquid electrolyte, said matrix having an overall planform (28);
an anode catalyst (12) disposed adjacent a portion of one surface of said matrix and a cathode catalyst disposed adjacent a portion of a second surface of said matrix opposite said one surface;
a wettable, porous anode substrate (16) extending over the anode side of said overall planform and a wettable, porous cathode substrate (17) extending over the cathode side of said overall planform;
a plurality of fuel flow channels (20) adjacent said anode substrate configured to conduct fuel from fuel inlets to fuel outlets over substantially said overall planform;
a plurality of oxidant flow field channels (21) adjacent said cathode substrate configured to conduct oxidant from oxidant inlets to oxidant outlets over substantially said entire planform;
at least one of said catalysts extending over a portion of said matrix which is less than said overall planform defining an active area (29) of the fuel cell, a portion of said matrix not adjacent one of said catalysts (i) being adjacent exits of (a) said fuel flow channels, or (b) said oxidant flow channels, or (c) both said fuel flow channels and said oxidant flow channels, and (ii) constituting an electrolyte condensation zone (27);
means configured to flow fuel (30-33) and oxidant (37-39) reactant gases through said respective flow channels, whereby, when said fuel cell apparatus is operating, electrolyte is evaporated into one or both of said reactant gases and electrolyte is condensed out of said one or both reactant gases in said condensation zone;
a plurality of fluid impermeable separator plates (19), said reactant flow channels formed within or adjacent to said separator plates, said separator plates interposed between adjacent fuel cells;
characterized by:
a plurality of wicks (49, 53, 58, 62, 65) configured to conduct electrolyte from said electrolyte condensation zone across said overall planform of each cell, said wicks having a mean pore size less than about one-half of the mean pore size of the pores in said substrates.

13. Apparatus according to claim 12, further characterized by:
said wicks having a mean pore size less than about one-quarter the mean pore size of the pores in said substrate.

14. Apparatus according to claim 12, further characterized by:
said wicks are disposed in each cell (a) within (49, 58) at least one of said substrates (16, 17), or (b) within (54) at least one of said separator plates (19), or (c) between (62, 65) at least one of said substrates and the corresponding adjoining separator plate.

15. Apparatus according to claim 12, further characterized by:
said separator plates (19) being substantially planar with flat opposed surfaces; and
said wicks comprising a plurality of ribs (65) disposed contiguously between (a) one or both surfaces of each separator plate and (b) corresponding substrates (16, 17), said ribs on surfaces adjacent to the anode substrates forming said fuel reactant gas flow channels, and said ribs adjacent the cathode substrates forming said oxidant reactant gas flow channels, said ribs providing both electrical continuity with and mechanical separation between said substrates and said separator plates.

16. Apparatus according to claim 12, further characterized by:
said separator plates (19) having additional channels extending inwardly from at least one of said opposite surfaces interspersed with substantially every N reactant gas flow channel (20, 21) extending from said at least one of said opposite surfaces, where N is a positive integer greater than one, and said wicks are (49) disposed within said additional channels.

17. Apparatus according to claim 12, further characterized by:
said wicks (49, 58) are disposed in at least some of said reactant gas flow channels (20, 21) extending inwardly from at least one of said opposite surfaces.

18. Apparatus according to claim 12, further characterized by:
said wicks (58) covering the base surface of substantially all of said reactant gas flow channels (20, 21) extending inwardly from at least one of said opposite surfaces.

19. Apparatus according to claim 12, further characterized by:
said separator plates (19) having ribs (50) defining said reactant gas flow channels (20, 21), and said wicks (62) are disposed between one or both of said substrates (16, 17) in each cell and the surfaces of the ribs of said separator plates facing said one or both substrates.

20. Apparatus according to claim 12, further characterized by:
said wicks (54) are disposed in each cell within zones (58) extending inwardly from a surface of at least one of said substrates (16, 17) in each cell adjacent to a corresponding one of said separator plates (19).

21. Apparatus according to claim 20, further characterized by:
said zones (53) extending only part way through said corresponding substrates (17, 17).

22. Apparatus according to claim 12 further characterized by in that:
a first plurality of said wicks (49, 53, 58, 62, 65), having a first amount of wicking material, are disposed adjacent to said anode substrate (16), and a second plurality of wicks, having a second amount of wicking material different from said first amount of wicking material, are disposed adjacent to said cathode substrate (17).
